(19) United States
(12) Patent Application Publication
(10) Pub. No.: US 2013/0163812 A1
(43) Pub. Date: Jun. 27, 2013

(54) INFORMATION PROCESSOR, INFORMATION PROCESSING METHOD, AND RECORDING MEDIUM

(71) Applicant: Shinya MUKASA, Shizuoka (JP)

(72) Inventor: Shinya MUKASA, Shizuoka (JP)

(73) Assignee: RICOH COMPANY, LTD., Tokyo (JP)

(21) Appl. No.: 13/688,489

(22) Filed: Nov. 29, 2012

(30) Foreign Application Priority Data
Dec. 22, 2011 (JP) 2011-281569

(51) Int. Cl. G06T 9/00

(52) U.S. Cl. CPC G06T 9/00
USPC 382/103

(57) ABSTRACT

An information processor includes an image capturing part configured to obtain a displayed screen image; a storage part configured to store the screen image each time the screen image is obtained; an image comparison part configured to generate one or more difference pixels by comparing a screen image stored last and the obtained screen image; a difference region determination part configured to determine the smallest rectangular region including the difference pixels as a difference region based on a predetermined rectangle formed of a predetermined number of pixels, the screen image being divided using the predetermined rectangle as a unit; a compressed difference image generation part configured to generate a compressed difference image by compressing a difference image using the predetermined rectangle as a unit, the difference region being cut out from the screen image into the difference image; and an image transmission part configured to transmit the compressed difference image.

### CROSS-REFERENCE TO RELATED APPLICATION

The present application is based upon and claims the benefit of priority of the prior Japanese Patent Application No. 2011-281569, filed on Dec. 22, 2011, the entire contents of which are incorporated herein by reference.

### BACKGROUND OF THE INVENTION

1. Field of the Invention

The present invention relates to an information processor, an information processing method, and a recording medium.

2. Description of the Related Art

At a conference and the like, a presentation is given by projecting a desktop screen of a personal computer (PC) onto a whiteboard or a screen using a projector. That is, in an environment where the PC and the projector are connected via a network, the PC captures desktop screen images at predetermined intervals, and transmits the captured desktop screen images to the projector as image data to be projected (projection image data), so that the projector projects the received projection image data.

In this case, a technique is known that reduces operational loads on the network by performing a pixel-by-pixel comparison of a captured desktop screen image and the last captured desktop screen image, extracting pixels with a difference (difference pixels), cutting out only a region of difference (difference region) from the desktop screen image, and transmitting the difference region to the projector. That is, only the difference region of parts of a desktop screen image of the PC, where changes have occurred, is transmitted to the projector, and the projector updates only the part of the difference region in the last projected desktop screen image by superimposing the received difference region on the last projected desktop screen image.

Here, in general, the image of the difference region of a desktop screen image transmitted from the PC to the projector is compressed in JPEG format or the like before transmission in order to reduce operational loads on the network.

As a technique related to this, Japanese Patent No. 4120711 illustrates a system that wirelessly communicates a video signal between a video signal generator such as a PC and a display apparatus such as a liquid crystal projector, where in order to reduce operational loads on the network, a transmitter that transmits the video signal encodes and transmits only part of the video signal where two consecutive frames of the video signal differ, and the display apparatus receives the encoded video signal and decodes the received video signal using a system corresponding to the encoding system to display a decoded image on a display screen.

### SUMMARY OF THE INVENTION

According to an aspect of the present invention, an information processor includes an image capturing part configured to obtain a screen image displayed on a display part; a storage part configured to store the screen image each time the screen image is obtained by the image capturing part; an image comparison part configured to generate one or more difference pixels by comparing a last screen image stored a last time by the storage part and the screen image obtained by the image capturing part; a difference region determination part configured to determine a smallest rectangular region that includes the one or more difference pixels as a difference region based on a predetermined rectangle formed of a predetermined number of pixels, wherein the screen image is divided using the predetermined rectangle as a unit; a compressed difference image generation part configured to generate a compressed difference image by performing compression on a difference image using the predetermined rectangle as a unit, wherein the difference region is cut out from the screen image into the difference image; and an image transmission part configured to transmit the compressed difference image to an image display unit connected to the information processor via a network.

According to an aspect of the present invention, a non-transitory computer-readable recording medium has a program recorded thereon, wherein the program is executed by a processor of an information processor to implement: an image capturing part configured to obtain a screen image displayed on a display part; a storage part configured to store the screen image each time the screen image is obtained by the image capturing part; an image comparison part configured to generate one or more difference pixels by comparing a last screen image stored a last time by the storage part and the screen image obtained by the image capturing part; a difference region determination part configured to determine a smallest rectangular region that includes the one or more difference pixels as a difference region based on a predetermined rectangle formed of a predetermined number of pixels, wherein the screen image is divided using the predetermined rectangle as a unit; a compressed difference image generation part configured to generate a compressed difference image by performing compression on a difference image using the predetermined rectangle as a unit, wherein the difference region is cut out from the screen image into the difference image; and an image transmission part configured to transmit the compressed difference image to an image display unit connected to the information processor via a network.

According to an aspect of the present invention, an information processing method includes obtaining a screen image displayed on a display part of an information processor; storing the screen image each time the screen image is obtained by said obtaining; generating one or more difference pixels by comparing a last screen image stored a last time by said storing and the screen image obtained by said obtaining; determining a smallest rectangular region that includes the one or more difference pixels as a difference region based on a predetermined rectangle formed of a predetermined number of pixels, wherein the screen image is divided using the predetermined rectangle as a unit; generating a compressed difference image by performing compression on a difference image using the predetermined rectangle as a unit, wherein the difference region is cut out from the screen image into the difference image; and transmitting the compressed difference image to an image display unit connected to the information processor via a network.

The object and advantages of the invention will be realized and attained by means of the elements and combinations particularly pointed out in the claims.

It is to be understood that both the foregoing general description and the following detailed description are exemplary and explanatory and not restrictive of the invention.

### BRIEF DESCRIPTION OF THE DRAWINGS

Other objects, features and advantages of the present invention will become more apparent from the following detailed description when read in conjunction with the accompanying drawings, in which:

FIG. 1 is a diagram illustrating a network configuration of a projection system according to an embodiment;

FIG. 2 is a block diagram illustrating a hardware configuration of a PC according to the embodiment;

FIG. 3 is a block diagram illustrating a hardware configuration of a projector according to the embodiment;

FIG. 4 is a functional block diagram illustrating the PC and the projector according to the embodiment;

FIG. 5 is a diagram illustrating a transition of the display (displayed) screen of the PC and a transition of the projection (projected) image of the projector according to the embodiment;

FIG. 6 is a diagram illustrating the cutting-out of a difference image of a PC according to a conventional case;

FIG. 7 is a diagram illustrating the synthesis of a difference image by a projector according to the conventional case;

FIG. 8 is a diagram illustrating the cutting-out of a difference image of the PC according to the embodiment;

FIG. 9 is a diagram illustrating synthesis of a difference image by the projector according to the embodiment;

FIG. 10 is a flowchart illustrating information processing of the projection system according to the embodiment;

FIG. 11 is a diagram where the difference image of the conventional case and the difference image according to the embodiment are compared;

FIG. 12 is a flowchart illustrating information processing of the projection system according to a variation; and

FIG. 13 is a diagram illustrating the cutting-out of a difference image of the PC according to the variation.

### DETAILED DESCRIPTION OF THE PREFERRED EMBODIMENTS

As described above, in general, the image of the difference region of a desktop screen image transmitted from the PC to the projector is compressed in JPEG format or the like before transmission. However, according to JPEG compression, processing is performed based on a unit called “macroblock.” Therefore, if the width or height of an image of the difference region is not divisible by the unit of the macroblock (that is, cannot be cut out in units of macroblocks), and the shortage of size (part of the image that does not fit in a macroblock) is compensated for by an estimated image. Therefore, noise is likely to be included in an edge portion of the difference region.

Accordingly, in the conventional projection system of transmitting a difference region from a PC to a projector, noise is often included in an edge portion of the difference region at the time of performing JPEG compression on the difference region. Therefore, there is a problem in that when the received difference region is superimposed on the last projected desktop screen image on the projector side, the boundary line of part of the last projected desktop screen image on which the difference region is superposed is likely to be conspicuous. That is, there is the problem of reduction in the quality of the image projected by the projector.

According to an aspect of the present invention, an information processor and an information processing method are provided that improve the quality of an image projected by a projector, and a recording medium on which a program is recorded for causing a computer to implement parts of such an information processor.

A description is given below, with reference to the accompanying drawings, of one or more embodiments of the present invention.

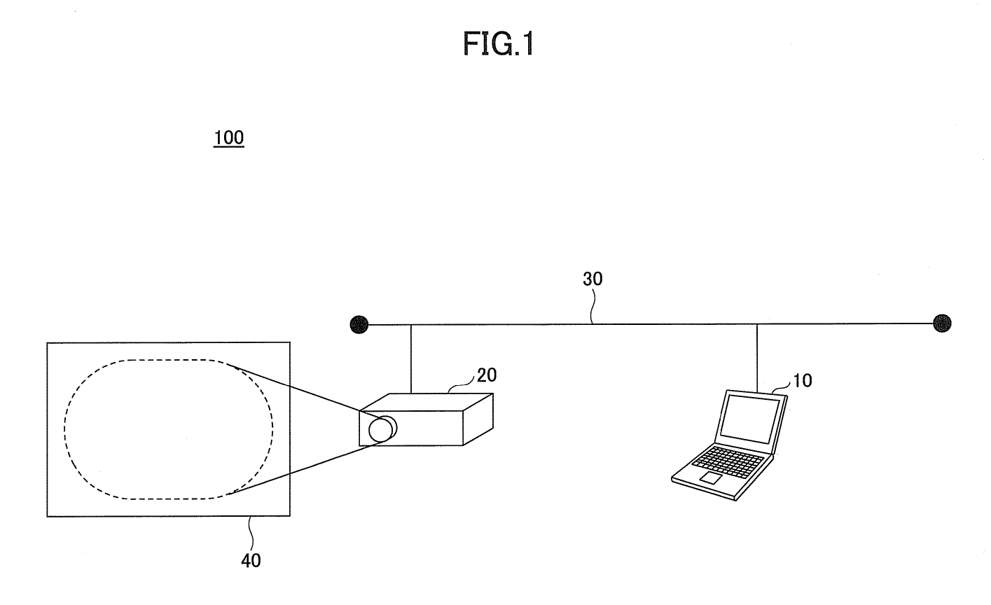

FIG. 1 is a diagram illustrating a network configuration of a projection system 100 according to an embodiment. The projection system 100 of this embodiment includes a PC 10 and a projector 20, which are interconnected via a network 30.

The PC 10, which is an information processor, is a PC terminal of a user. The PC 10 is connected to the projector 20 via the network 30, so that a presentation or the like is given by projecting a desktop screen of the PC 10 onto a whiteboard 40. That is, the PC 10 captures desktop screen images at predetermined intervals, and transmits the captured desktop screen images to, for example, the projector 20 as images to be projected (projection images), so that the projector 20 projects the received projection images onto the whiteboard 40.

The projector 20 receives a projection image from the PC 10, and projects the received projection image onto, for example, the whiteboard 40. The projector 20 is connected to the PC 10 via the network 30, so that a desktop screen image on the PC screen is transmitted from the PC 10 to the projector 20 as a projection image. The projector 20 projects this received projection image onto the whiteboard 40.

In this embodiment, the PC 10 captures desktop screen images at predetermined intervals. The PC 10 performs a pixel-by-pixel comparison of a captured screen image and the last captured screen image (the screen image captured the last or preceding time, that is, immediately before the captured screen image), extracts one or more pixels with a difference (hereinafter also referred to as “difference pixels”), cuts out only a region of difference (a difference region), and transmits the difference region to the projector 20 after performing JPEG compression on the difference region. That is, the PC 10 transmits only the difference region of parts of its desktop screen image, where changes have occurred, to the projector 20, and the projector 20 updates only the part of the difference region in the last projected desktop screen image (the desktop screen image projected the last or preceding time) by superimposing the received difference region on the last projected desktop screen image. A description is given in detail below of this process.

The network 30 is a wired or wireless communications network. Examples of the network 30 include a local area network (LAN) and a wide area network (WAN). The network 30 may be any network as long as the network allows the PC 10 to connect to and communicate with the projector 20. Further, the number of PCs 10 is not limited to one, and multiple PCs may be connected to the network 30.

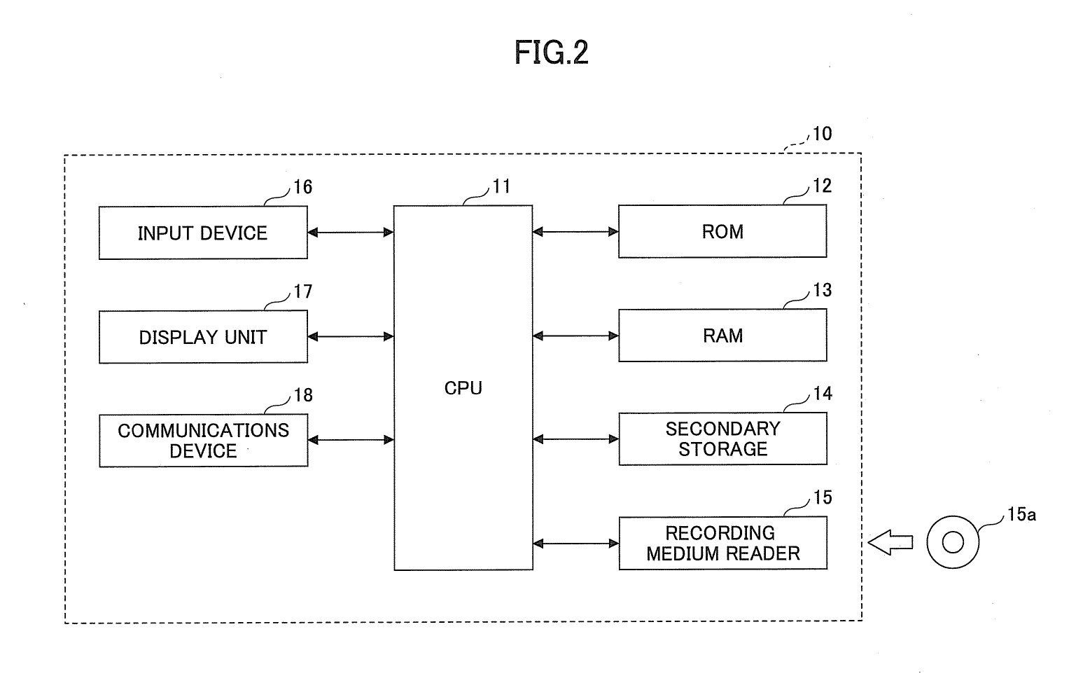

FIG. 2 is a block diagram illustrating a hardware configuration of the PC 10 according to the embodiment. The PC 10 includes a central processing unit (CPU) 11, a read-only memory (ROM) 12, a random access memory (RAM) 13, a secondary storage 14 such as a hard disk drive (HDD), a recording medium (storage medium) reader 15, an input device 16, a display unit 17, and a communications device 18.

The CPU 11 includes a microprocessor and its peripheral circuits, and performs overall control of the PC 10. The ROM 12 is a memory that contains a predetermined control program executed by the CPU 11. The RAM 13 is a memory that the CPU 11 uses as a work area when performing various control operations by executing the predetermined control program contained in the ROM 12. The secondary storage 14 is a non-volatile storage device that stores various kinds of information including a general-purpose operating system OS and various kinds of programs. The recording medium reader 15 is a device that inputs information from an external recording medium (storage medium) 15a such as a CD, a DVD, and a universal serial bus (USB) memory. The input device 16 is a device for a user performing various kinds of input operations. The input device 16 includes a mouse, a keyboard, and a touchscreen switch superimposed on the display screen of the display unit 17. The display unit 17 displays various kinds of data on its display screen. The display unit 17 includes, for example, a liquid crystal display (LCD) or a cathode ray tube (CRT). The communications device 18 performs communications with other devices or apparatuses via the network 30. The communications device 18 supports communications corresponding to various forms of networks including wired networks and wireless (radio) networks.

A program executed in the PC 10 may be provided by being recorded as a file of an installable or executable format on the computer-readable recording medium 15a.

Further, a program executed in the PC 10 may be provided by being stored in a computer connected to the network 30 and downloaded via the network 30. Further, a program executed in the PC 10 may be provided or distributed via the network 30.

Further, a program executed in the PC 10 may be provided by being incorporated into the ROM 12 or the like in advance.

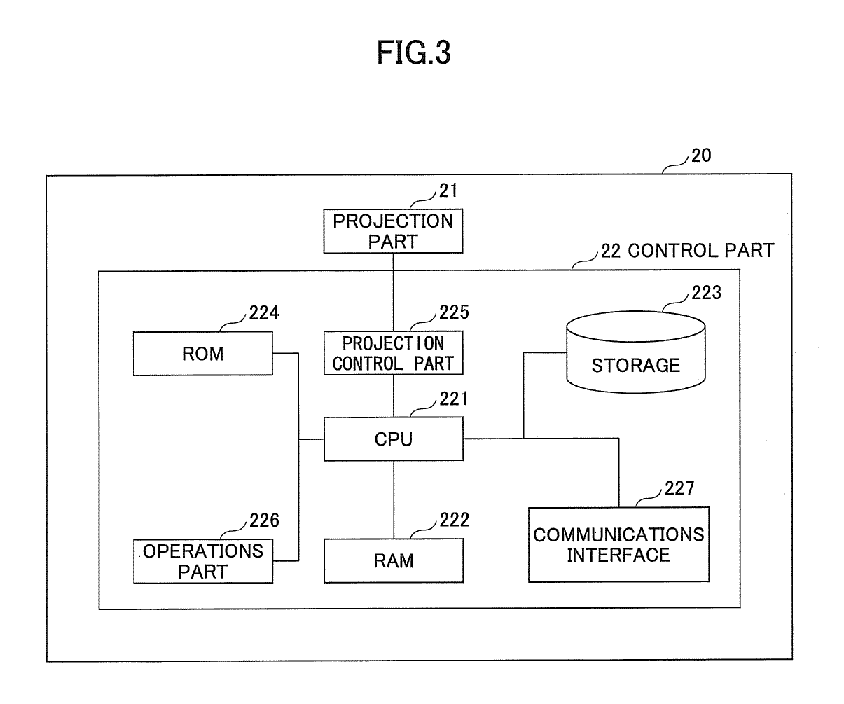

FIG. 3 is a block diagram illustrating a hardware configuration of the projector 20 according to the embodiment. The projector 20 includes a projection part 21 that projects a projection image (an image to be projected) (projects and visualizes projection image data) and a control part 22 that performs general control.

The projection part 21 projects a projection image. The projection part 21 visualizes projection image data as a projection image. The control part 22 includes a CPU 221 that controls the control part 22, a RAM 222 that the CPU 221 uses as a work area when executing a program to perform various control operations, a storage 223 that stores projection images, etc., a ROM 224 that contains a projector control program and parameters necessary for control, a projection control part 225 that transmits a command for power supply control and a command to project a generated projection image to the projection part 21, an operations part 226 that receives operation of the power supply of the projection part 21 and commands for selection, projection, page operations, etc., at an input device, and a communications interface 227 including an Ethernet (registered trademark) interface with the network 30 and an IrDA interface for remote control that makes it possible to perform the same operations as those performed by the operations part 226.

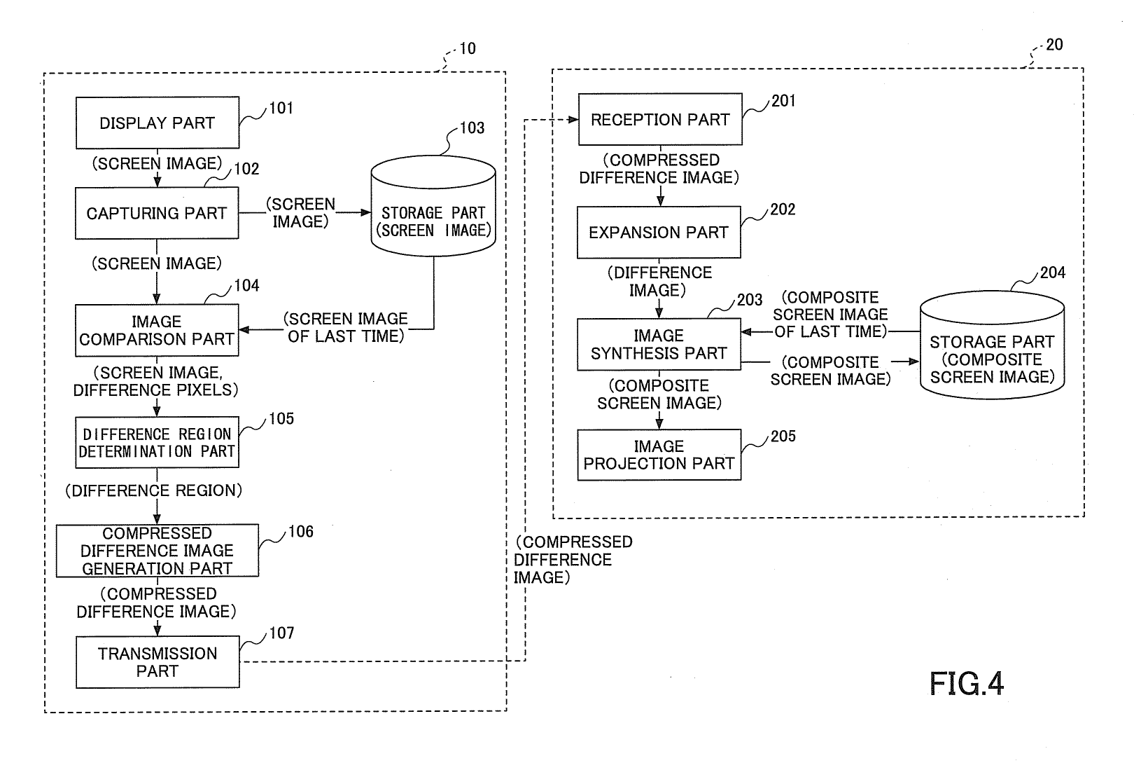

Next, a description is given of a functional configuration of the projection system 100 according to the embodiment. FIG. 4 is a functional block diagram illustrating the PC 10 and the projector 20 according to the embodiment.

The PC 10 includes a display part 101, a capturing part 102, a storage part 103, an image comparison part 104, a difference region determination part 105, a compressed difference image generation part 106, and a transmission part 107.

The display part 101 displays a screen image (a display screen) on the display screen of the display unit 17 (FIG. 2). The screen image is, for example, a desktop screen displayed on the PC 10, and this screen image is to be projected by the projector 20.

The capturing part 102 captures (obtains) the screen image displayed by the display part 101. That is, the capturing part 102 captures screen images to be projected by the projector 20 at predetermined intervals. The capturing interval is determined as desired by given settings. As the capturing interval becomes shorter, a change in the display screen of the PC 10 is reflected and projected by the projector 20 on a more real-time basis.

The storage part 103 stores the screen image obtained by the capturing part 102 in order to use the screen image for the next image comparison by the image comparison part 104.

The image comparison part 104 obtains the last-time screen image stored the last time from the storage part 103, and extracts one or more difference pixels by comparing the screen image of the last time and the screen image obtained this time on a pixel basis. That is, the image comparison part 104 extracts a changed part (one or more changed pixels) on the display screen of the PC 10.

The difference region determination part 105 determines the difference region based on the difference pixels extracted by the image comparison part 104 and the macroblock that is the unit of processing of JPEG compression. This is described in detail below.

The compressed difference image generation part 106 cuts out an image within the difference region (referred to as “difference image”) from the screen image of this time (current screen image), and generates a compressed difference image by performing JPEG compression on the cut-out difference image. The difference image, which is used as part of a projection image on the projector 20 side, is subjected to compression in order to reduce operational loads on the network 30 due to transmission of the difference image data.

The transmission part 107 transmits the compressed difference image, which is the difference image subjected to compression, to the projector 20.

The projector 20 includes a reception part 201, an expansion part 202, an image synthesis part 203, a storage part 204, and an image projection part 205.

The reception part 201 receives the compressed difference image, which is the difference image subjected to compression, from the PC 10.

The expansion part 202 expands the compressed difference image received from the PC 10 because the compressed difference image is the difference image that has been compressed.

The image synthesis part 203 obtains the composite screen image (that is, the projection image) of the last time from the storage part 204, and synthesizes (combines) the last (preceding) composite screen image and the difference image received in a current instance by superimposing the received difference image on the last composite screen image, thereby generating a composite screen image (projection image) to be projected in the current instance. Further, the image synthesis part 203 stores the generated composite screen image in the storage part 204.

The storage part 204 stores the composite screen image (projection image) generated by the image synthesis part 203 in order to use the composite screen image for the next image synthesis by the image synthesis part 203.

The image projection part 205 projects the composite screen image generated by the image synthesis part 203. That is, the image projection part 205 controls the projection part 21 (FIG. 3), and projects and visualizes the composite screen image as a projection image.

A description is given above of functional configurations of the PC 10 and the projector 20. In practice, the above-described functions are implemented by computers based on programs executed by the CPUs 11 and 221 of the PC 10 and the projector 20. For example, a utility program for the projector 20 is installed in advance in the PC 10, for example.

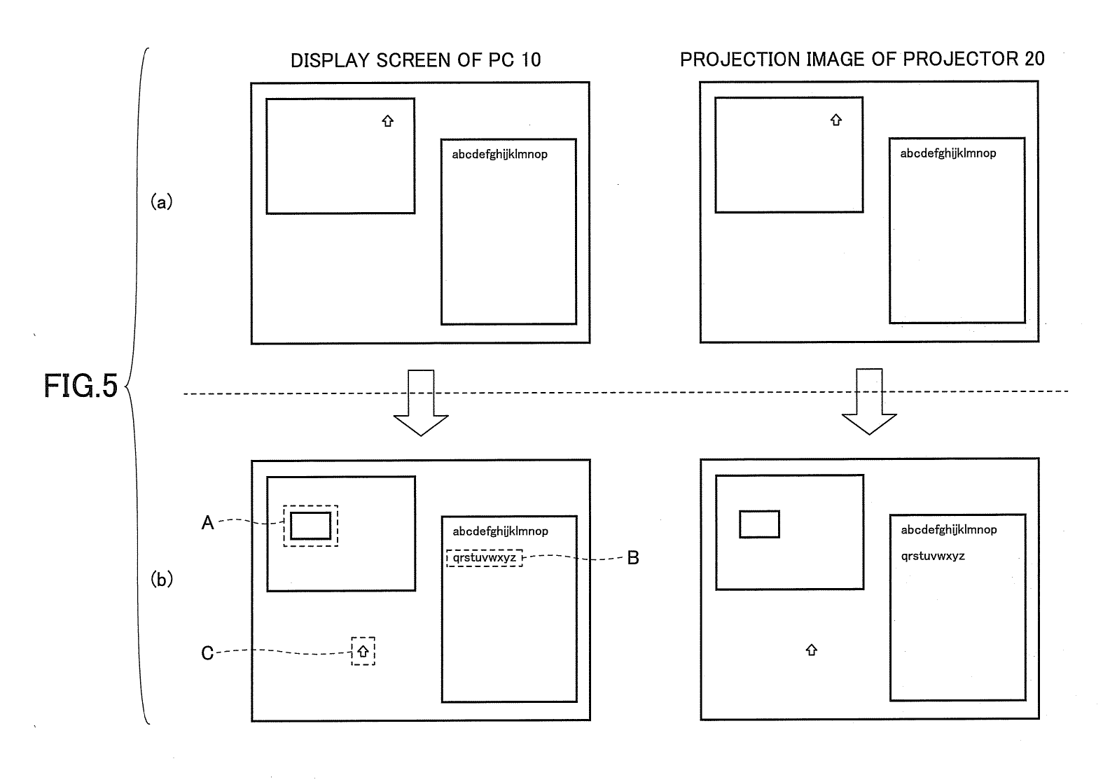

FIG. 5 is a diagram illustrating a transition of the display (displayed) screen of the PC 10 and a transition of the projection (projected) image of the projector 20 according to the embodiment.

As illustrated in (a) of FIG. 5, when the display screen of (a) is displayed in the PC 10, the same screen as the display screen of the PC 10 is projected by the projector 20.

Here, it is assumed that Object A and Object B are added to and Object C is moved downward on the display screen of the PC 10 illustrated in (a) of FIG. 5 by, for example, a user. At this point, a difference image is transmitted from the PC 10 to the projector 20, so that the same screen as the display screen of the PC 10 is projected by the projector 20 as illustrated in (b) of FIG. 5.

That is, the PC 10 cuts out a difference image between the screen image of (a) of FIG. 5, which is the screen image of the last time, and the screen image of (b) of FIG. 5, which includes a change caused this time, and transmits the difference image to the projector 20 after compressing the difference image. After expanding the received compressed difference image, the projector 20 combines the difference image with the projection image of (a) of FIG. 5, which is the projection image of the previous (preceding) time, so that the difference image is superimposed on the projection image, thereby generating and projecting the projection image of (b) of FIG. 5.

The difference image alone is transmitted in order to reduce operational loads on the network 30 due to data transmission compared with the case of transmitting the whole screen image. Likewise, compression is performed in order to reduce operational loads on the network 30 due to data transmission.

Next, a description is given, comparing the conventional case and the embodiment of the present invention, of cutting out a difference image to be transmitted to the projector 20.

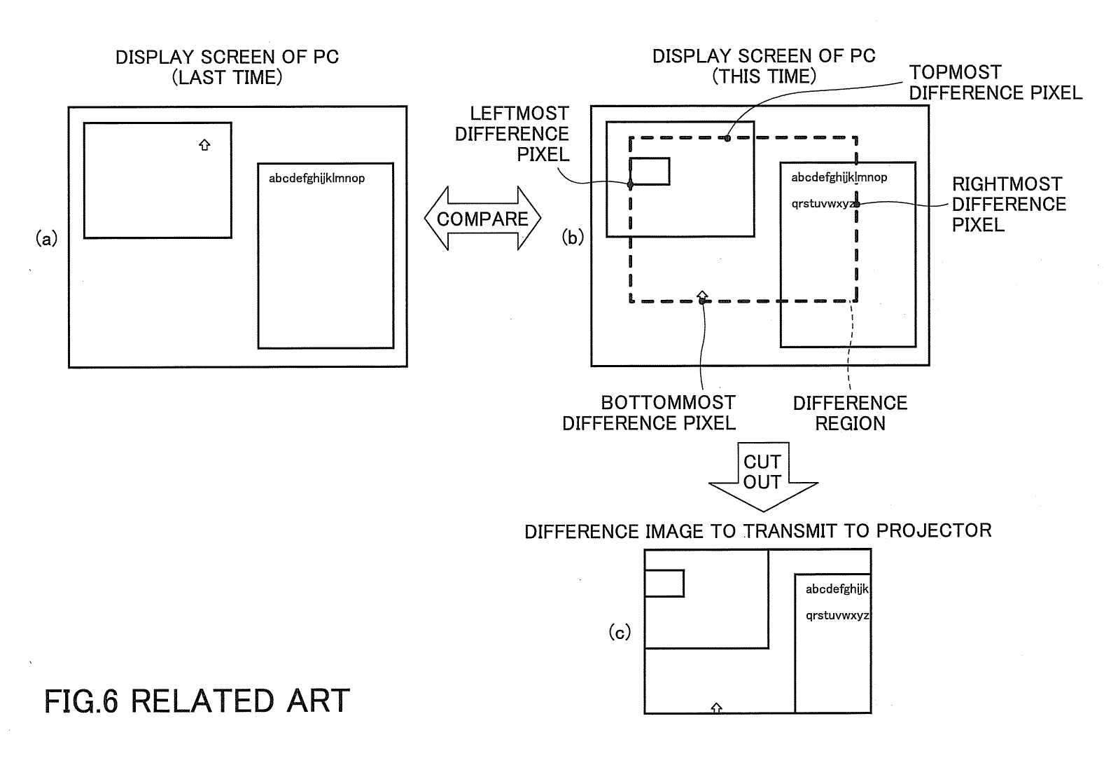

FIG. 6 is a diagram illustrating the cutting-out of a difference image of a PC according to the conventional case. On the PC side, a screen image captured in a current instance and a screen image captured in the previous (preceding) instance are compared on a pixel basis, and one or more pixels with a difference (referred to as “difference pixels”) are extracted. Then, a rectangle that is circumscribed about the leftmost difference pixel, the rightmost difference pixel, the topmost difference pixel, and the bottommost difference pixel of the extracted difference pixels is determined as a difference region, and only a difference image, which is an image included in the difference region, is cut out from the screen image captured this time. This difference image is subjected to JPEG compression and is thereafter transmitted to a projector. Coordinate information that indicates the position of the difference image on the screen image is also transmitted to the projector. For example, since the difference image is rectangular, the coordinate information of at least two diagonal corners (points) of the four corners is transmitted.

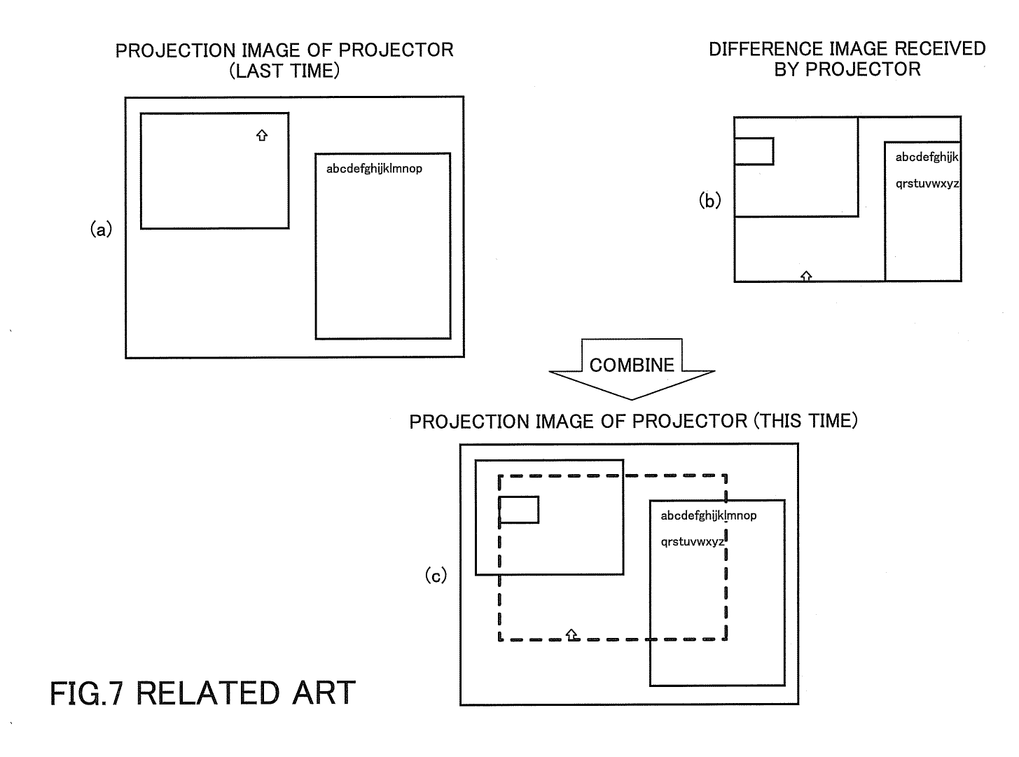

FIG. 7 is a diagram illustrating the synthesis of a difference image by the projector according to the conventional case.

On the projector side, after expansion of the received difference image, the difference image received this time and the screen image (the whole screen image) projected the last time are synthesized (combined) in accordance with the coordinate information. That is, on the screen image projected in the previous instance, a difference region, in which the screen has changed, alone is updated by superimposing the difference image on the difference region. Then, the projector projects this composite screen image as a projection image. Thereby, screen transitions are performed in the conventional case.

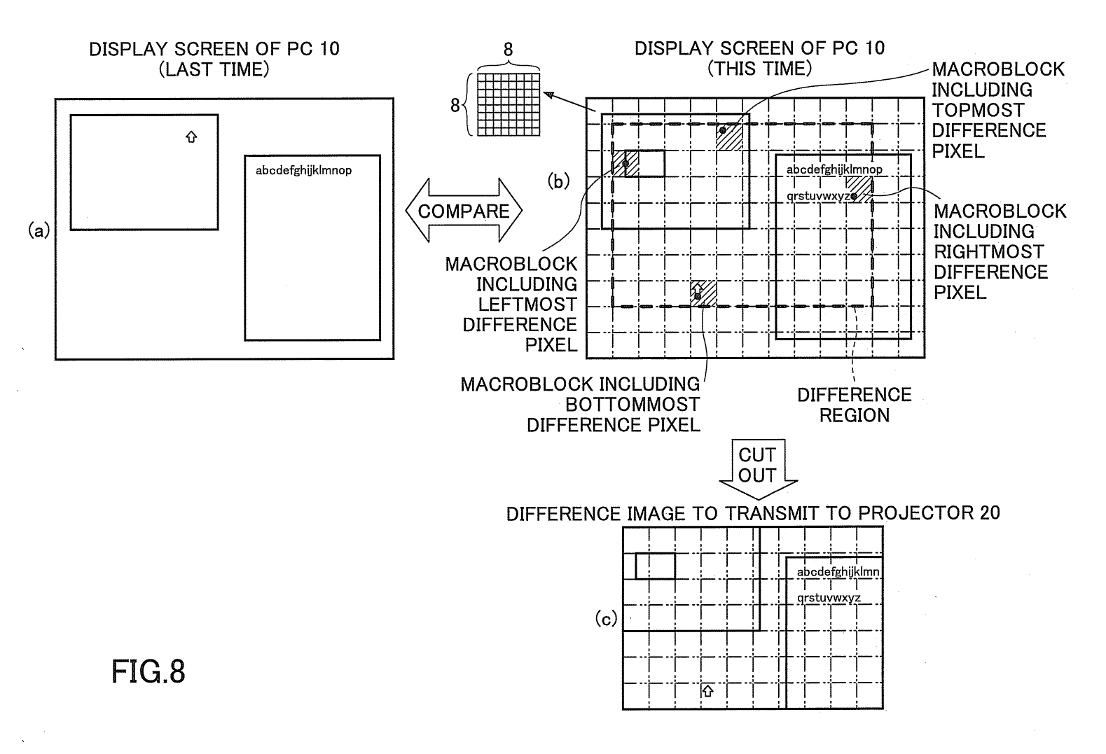

FIG. 8 is a diagram illustrating the cutting-out of a difference image of the PC 10 according to the embodiment.

The PC 10 compares a screen image captured this time ((a) of FIG. 8) and a screen image captured the last time ((b) of FIG. 8) on a pixel basis (that is, performs a pixel-by-pixel comparison of the newly captured screen image and the last captured screen image), and extracts one or more pixels with a difference (referred to as “difference pixels”). Further, the PC 10 divides the screen image captured this time into macroblocks. The macroblock is the unit of processing of JPEG compression, and is a predetermined rectangle (including a square) containing 8×8 pixels per macroblock, for example. The number of the pixels included in a screen image corresponds to resolution. Therefore, usually, the number of pixels of the screen image is divisible by eight (8). That is, the screen image is divisible by an integer number of macroblocks (with no remainder).

Then, the PC 10 determines the smallest (minimum) rectangular region of macroblocks that include all the extracted difference pixels as a difference region. That is, a rectangular region that is circumscribed about a macroblock that includes the leftmost difference pixel, a macroblock that includes the rightmost difference pixel, a macroblock that includes the topmost difference pixel, and a macroblock that includes the bottommost difference pixel of the extracted difference pixels is determined as the difference region (indicated by a solid broken line in (b) of FIG. 8).

Next, the PC 10 cuts out a difference image, which is an image included in the difference region, alone from the screen image captured this time (as illustrated in (c) of FIG. 8), performs JPEG compression on this difference image on a macroblock basis, and transmits the compressed difference image to the projector 20. Further, the PC 10 also transmits coordinate information that indicates the position of the difference image on the screen image to the projector 20.

Here, the difference image is cut out from the screen image on a macroblock basis (in units of macroblocks). Therefore, the data of the difference image (difference image data) is of a size that is always divisible by the unit of the macroblock, so that noise due to compression is less likely to be included in the difference image at the time of its JPEG compression. In the conventional case, when the width or height of an image of the difference region is not divisible by the unit of the macroblock (that is, cannot be cut out in units of macroblocks) depending on the size of the difference region, the shortage of size is compensated for by an estimated image. Therefore, noise is likely to be included in an edge portion of the difference region.

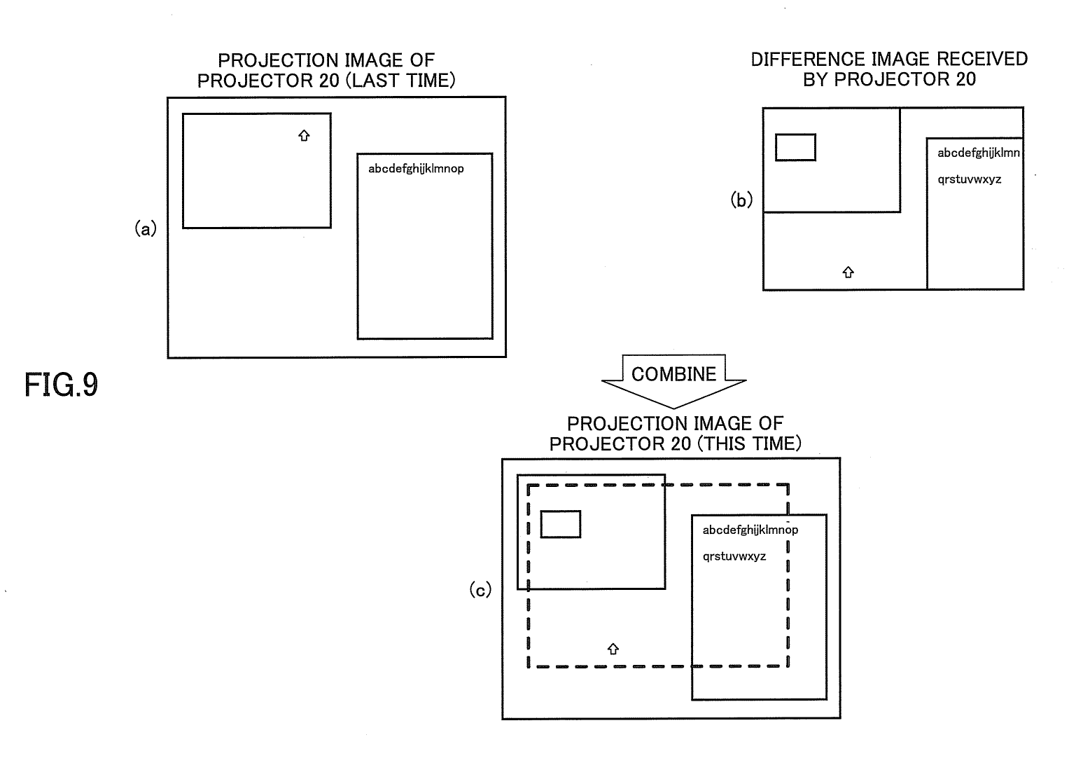

FIG. 9 is a diagram illustrating synthesis of a difference image by the projector 20 according to the embodiment.

After expanding the received difference image, the projector 20 synthesizes (combines) the difference image received this time and the screen image (the whole screen image) projected the last time in accordance with the coordinate information. That is, on the screen image projected the last time, a difference region, in which the screen has changed, alone is updated by superimposing the difference image on the difference region. Then, the projector 20 projects this composite screen image as a projection image. Thereby, the screen transitions as illustrated in FIG. 5 are performed according to the embodiment.

Here, noise is less likely to be included in an edge portion of the received difference image. Therefore, the difference image has good image quality. Further, part of the projection image projected by the projector 20 where the difference image is combined (in particular, the edge of the combined difference image) has good image quality. Therefore, the whole projection image is expected to have high image quality. Meanwhile, in the conventional case, noise is likely to be included in an edge portion of the difference region depending on the size of the difference region. Therefore, part of the projection image projected by the projector where the difference image is combined (in particular, the edge of the combined difference image) may be conspicuous.

Next, a description is given in detail of information processing in the projection system 100 according to the embodiment. That is, a description is given in detail of the operation outlined above.

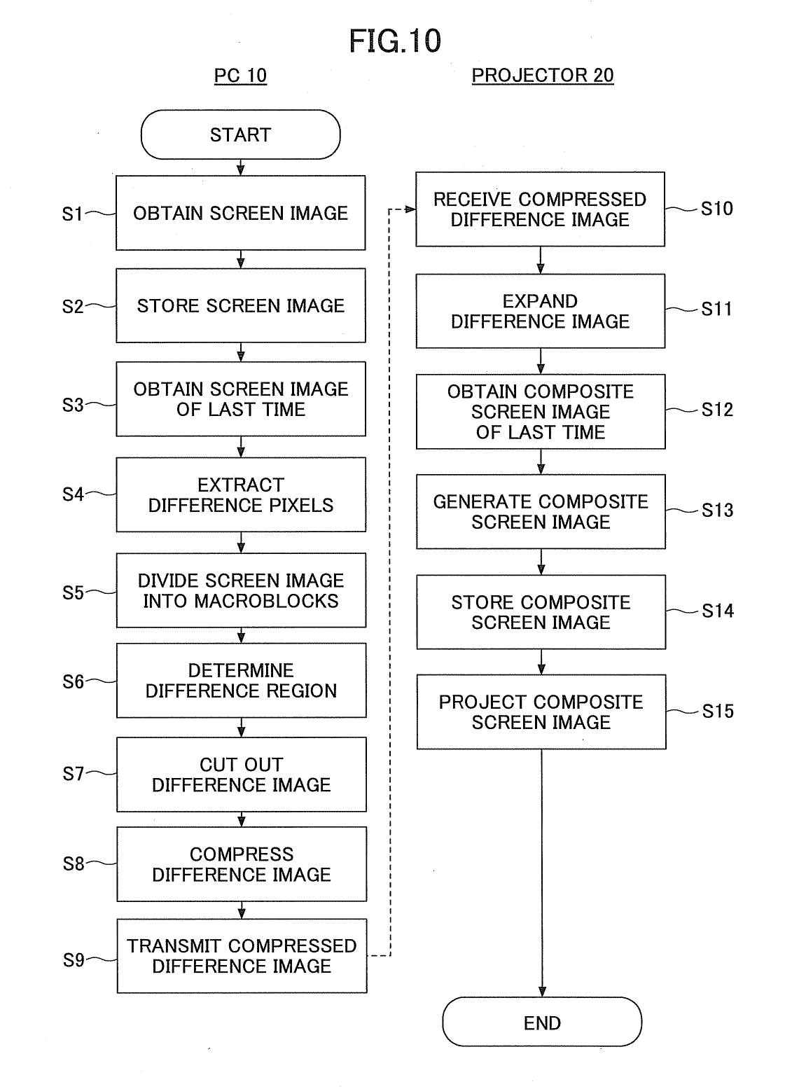

FIG. 10 is a flowchart illustrating information processing of the projection system 100 according to the embodiment. For example, the PC 10 cuts out a difference image to transmit to the projector 20 from the display screen of the PC 10, performs JPEG compression on the difference image, and transmits the compressed difference image to the projector 20. Upon receiving the compressed difference image, the projector 20 expands the received difference image, synthesizes the expanded difference image and the projection image of the last time by superimposing the difference image on the projection image, and projects this composite screen image. A detailed description is given below.

Referring to FIG. 10 as well as FIG. 4, in step S1, first, the capturing part 102 of the PC 10 obtains (captures) a screen image (for example, a desktop screen image) displayed on the display part 101. That is, the capturing part 102 captures screen images to be projected by the projector 20 at predetermined (time) intervals. The capturing interval may be determined as desired by given settings, and a screen image is captured upon arrival of a set capturing time. That is, the flow illustrated in FIG. 10 is started.

In step S2, the storage part 103 stores the screen image captured by the capturing part 102 in order to use the captured image for the next image comparison by the image comparison part 104.

In step S3, the image comparison part 104 obtains the last-time screen image stored the last time from the storage part 103. The storage part 103 may store screen images by adding information such as serial management numbers and/or the date and time of storage to the screen images in order to determine whether a screen image is the one of the last time.

Alternatively, screen images other than the one of the last time, which are not to be used, may be deleted from the storage part 103. That is, in this case, when the image comparison part 104 has obtained the screen image of the last time, the storage part 103 deletes the screen image of the last time.

In step S4, the image comparison part 104 compares the screen image of the last time obtained from the storage part 103 and the screen image captured this time (in the current operation) by the capturing part 102 on a pixel basis, and extracts one or more difference pixels, which are pixels whose pixel values have changed (that is, in which there is a change in pixel value). That is, the image comparison part 104 extracts a changed part (pixels with a change) of the display screen of the PC 10.

For example, referring back to FIG. 5 and FIG. 8, on the display screen of the PC 10, object A and Object B are added to and Object C is moved downward on the display screen of the PC 10 ((a) of FIG. 5 and FIG. 8) by, for example, a user. At this point, the changed part is pixels corresponding to the rendering parts of Object A, Object B, and Object C and pixels corresponding to the rendering part of Object C before its movement.

In step S5, the difference region determination part 105 divides the screen image captured this time into macroblocks. The macroblock is the unit of processing of JPEG compression, and is a predetermined rectangle (including a square) of 8×8 pixels per macroblock, for example. The number of the pixels included in a screen image corresponds to resolution. Therefore, usually, the number of pixels of the screen image is divisible by eight (8). That is, the screen image is divisible by an integer number of macroblocks (with no remainder).

In step S6, the difference region determination part 105 determines the difference region based on the difference pixels extracted by the image comparison part 104 and the macroblock that is the unit of processing of JPEG compression.

For example, referring again to FIG. 8, the difference region determination part 105 determines the smallest rectangular region of macroblocks that includes all the extracted difference pixels as the difference region. That is, a rectangular region (including a square region) that is circumscribed about a macroblock that includes the leftmost difference pixel, a macroblock that includes the rightmost difference pixel, a macroblock that includes the topmost difference pixel, and a macroblock that includes the bottommost difference pixel of the extracted difference pixels is determined as the difference region. In the case illustrated in FIG. 8, the difference region is a rectangular region of (vertical) 7×(horizontal) 10 macroblocks (within a solid broken line in (b) of FIG. 8).

Since the difference region is rectangular, the difference region may be determined by identifying the coordinate information of at least two diagonal corners (points) of the four corners.

For example, the difference region may be calculated from the size of the macroblock and the coordinates of the difference pixels as follows.

Letting the width and the height of the macroblock be Xb and Yb, respectively, it is assumed that the coordinates of the difference pixels are (X1, Y1), (X2, Y2), (Xn, Yn). The minimum (smallest) value of X1, X2, . . . , and Xn is expressed as min(X1, X2, Xn), the maximum (largest) value of X1, X2, . . . , and Xn is expressed as max(X1, X2, . . . , Xn), the minimum (smallest) value of Y1, Y2, . . . , and Yn is expressed as min(Y1, Y2, . . . , Yn), the maximum (largest) value of Y1, Y2, . . . , and Yn is expressed as max(Y1, Y2, . . . , Yn), the largest integer smaller than or equal to X is expressed as floor(X), the smallest integer greater than or equal to X is expressed as ceil(X), the largest integer smaller than or equal to Y is expressed as floor(Y), and the smallest integer greater than or equal to Y is expressed as ceil(Y). Then, the top-left coordinates (Xs, Ys) and the bottom-right coordinates (Xe, Ye) of the difference region is calculated by the following equations:

Xs=floor(min(X1,X2, . . . ,Xn)÷Xb)×Xb,

Ys=floor(min(Y1,Y2, . . . ,Yn)÷Yb)×Yb,

Xe=ceil(max(X1,X2, . . . ,Xn)÷Xb)×Xb,and

Ye=ceil(max(Y1,Y2, . . . ,Yn)÷Yb)×Yb.

Thus, the difference region may be determined by the top-left coordinates (Xs, Ys) and the bottom-right coordinates (Xe, Ye), which are two diagonal points of the rectangular difference region.

In step S7, the compressed difference image generation part 106 cuts out a difference image, which is an image inside the difference region, from the screen image captured this time based on the coordinate information of the difference region. For example, referring back to FIG. 8, an image inside the determined difference region (the rectangular region of 7×10 macroblocks) in the screen image captured this time is cut out as a difference image to be transmitted to the projector 20. Further, at the time of the cutting, coordinate information that indicates the position of the difference image on the screen image is also obtained. This coordinate information may be the same as the coordinate information of the two points that identify (specify) the coordinate information of the difference region (step S6).

In step S8, the compressed difference image generation part 106 generates a compressed difference image by performing JPEG compression on the cut-out difference image on a macroblock basis in order to reduce operational loads on the network 30 due to transmission of the difference image data.

At this point, since the difference image is cut out from the screen image in units of macroblocks in step S6 and step S7, the difference image data are always of a size divisible by the unit of the macroblock, so that noise due to compression is less likely to be included at the time of the JPEG compression of the difference image. Meanwhile, in the conventional case, when the width or height of an image of the difference region is not divisible by the unit of the macroblock (that is, cannot be cut out in units of macroblocks) depending on the size of the difference region, the shortage of size is compensated for by an estimated image. Therefore, noise is likely to be included in an edge portion of the difference region.

In step S9, the transmission part 107 transmits the compressed difference image, which is the difference image subjected to compression, to the projector 20. Further, the transmission part 107 also transmits coordinate information that indicates the position of the difference image on the screen image to the projector 20.

In step S10, the reception part 201 of the projector 20 receives the compressed difference image, which is the difference image subjected to compression, from the PC 10. Further, the reception part 201 also receives the coordinate information that indicates the position of the difference image on the screen image from the PC 10.

In step S11, the expansion part 202 expands the compressed difference image received from the PC 10.

In step S12, the image synthesis part 203 obtains the composite screen image (or the projection image) of the last time from the storage part 204.

In step S13, the image synthesis part 203 synthesizes the composite screen image of the last time (in the last operation) obtained from the storage part 204 and the difference image of this time (in the current operation) by superimposing the difference image of this time on the composite screen image of the last time based on the coordinate information that indicates the position of the difference image on the screen image, thereby generating a composite screen image to be projected this time. For example, referring back to FIG. 9, a composite screen image is generated as a projection image to be projected this time by synthesizes the composite screen image of the last time and the difference image of this time by superimposing the difference image of this time on the composite screen image of the last time based on the coordinate information that indicates the position of the difference image on the screen image.

In step S14, the storage part 204 stores the composite screen image generated by the image synthesis part 203 in order to use the composite screen image for the next image synthesis by the image synthesis part 203. The storage part 204 may store composite screen images by adding information such as serial management numbers and/or the date and time of storage to the composite screen images in order to determine whether a composite screen image is the one of the last time. Alternatively, composite screen images other than the one of the last time, which are not to be used, may be deleted from the storage part 204. That is, in this case, when the image synthesis part 203 has obtained the composite screen image of the last time, the storage part 204 deletes the composite screen image of the last time.

In step S15, the image projection part 205 projects the composited screen image generated by the image synthesis par 203. Thus, the screen transitions as illustrated in FIG. 5 are performed in this flowchart.

Here, noise is less likely to be included in an edge portion of the difference image received by the projector 20. Therefore, the received difference image has good image quality. Further, part of the projection image projected by the projector 20 where the difference image is combined (in particular, the edge of the combined difference image) has good image quality. Therefore, the whole projection image is expected to have high image quality. Meanwhile, in the conventional case, noise is likely to be included in an edge portion of the difference region depending on the size of the difference region. Therefore, part of the projection image projected by the projector where the difference image is combined (in particular, the edge of the combined difference image) may be conspicuous.

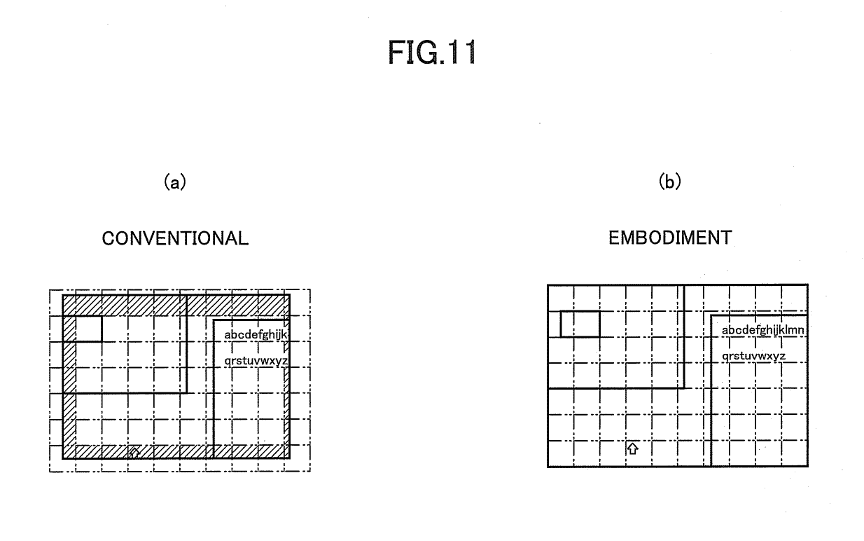

FIG. 11 is a diagram where the difference image of the conventional case and the difference image according to the embodiment are compared. In FIG. 11, the difference image to be transmitted to the projector according to the conventional case (illustrated in (a)) corresponds to the difference image illustrated in (c) of FIG. 6. The difference image to be transmitted to the projector 20 according to the embodiment (illustrated in (b)) corresponds to the difference image illustrated in (c) of FIG. 8.

Each of the difference images is subjected to JPEG compression on a macroblock basis on the PC side. However, the difference image to be transmitted to the projector according to the conventional case includes a portion (indicated by oblique lines) that is not divisible by the unit of the macroblock as illustrated in (a) of FIG. 11. Therefore, this portion (indicated by oblique lines) is compensated for by an estimated image at the time of JPEG compression, so that noise is likely to be included in an edge portion of the difference region. Further, in the projection image projected by the projector, the edge of a part (indicated by oblique lines) where the difference image is combined may be conspicuous.

Next, a description is given of a variation, which is different from the above-described embodiment in the method of determining the difference region. For example, the variation is different from the above-described embodiment in the process of step S5 and step S6 of the above-described flowchart of FIG. 10.

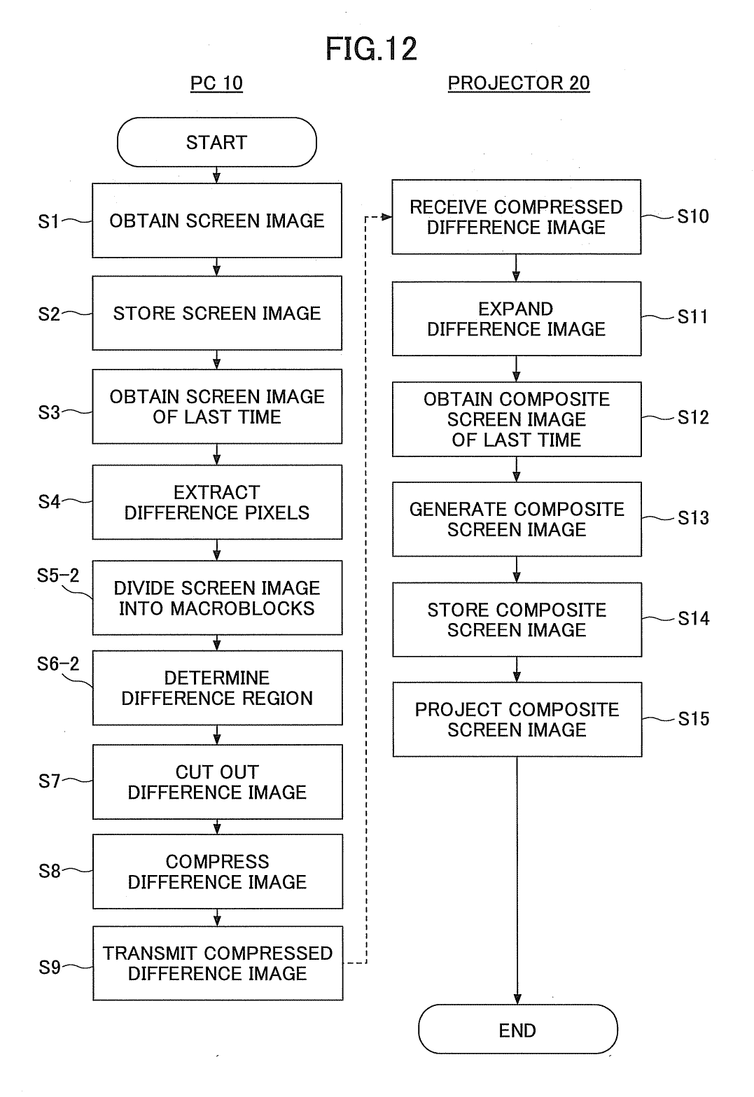

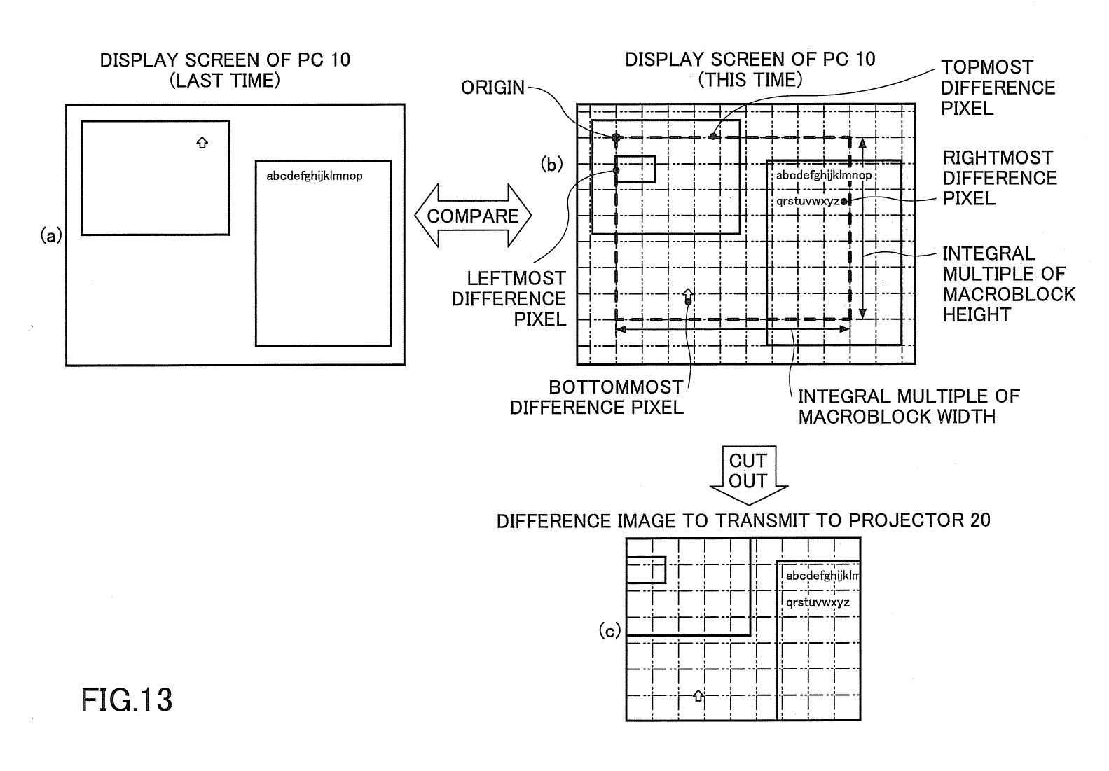

FIG. 12 is a flowchart illustrating information processing of the projection system 100 according to the variation. Since the information processing of the variation may be different from that of the above-described embodiment in the process of step S5 and step S6 alone, a description is given of the variation, replacing step S5 and step S6 of FIG. 10 with step S5-2 and step S6-2, respectively. The other steps are common to FIG. 10 and FIG. 12. FIG. 13 is a diagram illustrating the cutting-out of a difference image of the PC 10 according to the variation. FIG. 13 is also referred to in the following description.

In step S5-2, the difference region determination part 105 divides the screen image captured this time into macroblocks. According to the variation, the screen image is divided into macroblocks using the leftmost difference pixel (the x coordinate of the leftmost difference pixel) and the topmost difference pixel (the y coordinate of the topmost difference pixel) of the difference pixels extracted in step S4 as an “origin” (a starting point). For example, referring to FIG. 13, the screen image is divided into macroblocks using the leftmost difference pixel (more precisely, the x coordinate of the leftmost difference pixel) and the topmost difference pixel (more precisely, the y coordinate of the topmost difference pixel) as an origin.

Since the origin of the above-described embodiment is one of the corner points of the four corners of the rectangular screen image (for example, the topmost, leftmost point), the screen image may be divided into an integer number of macroblocks with no remainder (for example, FIG. 8). Meanwhile, the origin of the variation is based on the leftmost difference pixel and the topmost difference pixel of the screen image. Therefore, since the single macroblock is formed of, for example, 8×8 pixels as described above and the number of pixels of the whole screen image remains the same, one or more odd pixels that do not fit in a single macroblock may be generated at the top end, the bottom end, the right end, and/or the left end of the screen image, depending on the position of the origin of the variation. However, such a portion of the screen image (where one or more odd pixels may be generated) is not an object of compression or transmission, thus causing no problem in particular.

In step S6-2, the difference region determination part 105 determines the difference region based on the difference pixels extracted by the image comparison part 104 and the macroblock that is the unit of processing of JPEG compression.

For example, referring again to FIG. 13, the difference region determination part 105 determines the smallest rectangular region of macroblocks that includes all the extracted difference pixels in a direction toward the bottom right from the origin as the difference region. That is, a rectangular region that is circumscribed about a macroblock that includes the rightmost difference pixel of the difference pixels in the rightward direction from the origin and a macroblock that includes the bottommost difference pixel of the difference pixels in the downward direction from the origin is determined as the difference region. In the case illustrated in FIG. 13, the difference region is a rectangular region of (vertical) 7×(horizontal) 9 macroblocks (within a solid broken line in (b) of FIG. 13).

As described above, since the difference region is rectangular, the difference region may be determined by identifying the coordinate information of at least two diagonal corners (points) of the four corners. For example, the difference region may be calculated from the size of the macroblock and the coordinates of the difference pixels as follows.

Letting the width and the height of the macroblock be Xb and Yb, respectively, it is assumed that the coordinates of the difference pixels are (X1, Y1), (X2, Y2), . . . , (Xn, Yn). The minimum (smallest) value of X1, X2, . . . , and Xn is expressed as min(X1, X2, Xn), the maximum (largest) value of X1, X2, . . . , and Xn is expressed as max(X1, X2, . . . , Xn), the minimum (smallest) value of Y1, Y2, . . . , and Yn is expressed as min(Y1, Y2, . . . , Yn), the maximum (largest) value of Y1, Y2, . . . , and Yn is expressed as max(Y1, Y2, . . . , Yn), the largest integer smaller than or equal to X is expressed as floor(X), the smallest integer greater than or equal to X is expressed as ceil(X), the largest integer smaller than or equal to Y is expressed as floor(Y), and the smallest integer greater than or equal to Y is expressed as ceil(Y). Then, the top-left coordinates (Xs, Ys) and the bottom-right coordinates (Xe, Ye) of the difference region is calculated by the following equations:

Xs=min(X1,X2,Xn),

Ys=min(Y1,Y2,Yn),

Xe=max(X1,X2,Xn),and

Ye=max(Y1,Y2,Yn),

where Xe is substituted by Xe=Xs+ceil ((Xe−Xs) Xb)×Xb if (Xe−Xs) is not divisible by Xb, and Ye is substituted by Ye=Ys+ceil ((Ye−Ys)÷Yb)×Yb if (Ye−Ys) is not divisible by Yb.

Thus, the difference region may be determined by the top-left coordinates (Xs, Ys) and the bottom-right coordinates (Xe, Ye), which are two diagonal points of the rectangular difference region.

The process subsequent to step S6-2 is the same as the process subsequent to step S6 of FIG. 10. For example, in step S7, the compressed difference image generation part 106 cuts out a difference image, which is an image inside the difference region, from the screen image captured this time based on the coordinate information of the difference region, and in step S8, the compressed difference image generation part 106 performs JPEG compression on the cut-out difference image on a macroblock basis. For example, referring again to FIG. 13, an image inside the determined difference region (the rectangular region of 7×9 macroblocks) in the screen image captured this time is cut out as a difference image to be transmitted to the projector 20.

Thus, in the above-described embodiment, a rectangular region that is circumscribed about a macroblock that includes the leftmost difference pixel, a macroblock that includes the rightmost difference pixel, a macroblock that includes the topmost difference pixel, and a macroblock that includes the bottommost difference pixel of the extracted difference pixels is determined as the difference region, while in the variation, a rectangular region that is circumscribed about a macroblock that includes the rightmost difference pixel of the difference pixels in the rightward direction from the origin and a macroblock that includes the bottommost difference pixel of the difference pixels in the downward direction from the origin is determined as the difference region. Thus, according to the above-described embodiment, an additional pixel region may be present in one or more of the top, bottom, right, and left macroblocks, while according to the variation, an additional pixel region may be present only in the bottom-right macroblock. That, the difference region may be smaller in the variation than in the above-described embodiment, depending on the origin in the variation. Thus, according to the variation, operational loads on the network 30 due to transmission of data (a compressed difference image) may be further reduced.

In the variation, the difference image is cut out from the screen image in units of macroblocks using a point that is based on the leftmost difference pixel and the topmost difference pixel as an origin. Therefore, also in the variation, the data of the difference image to be transmitted to the projector 20 (difference image data) are always of a size divisible by the unit of the macroblock, so that noise due to compression is less likely to be included at the time of the JPEG compression of the difference image the same as in the above-described embodiment.

Further, in the variation, as illustrated in FIG. 13, the screen image is divided into macroblocks using the leftmost difference pixel (more precisely, the x coordinate of the leftmost difference pixel) and the topmost difference pixel (more precisely, the y coordinate of the topmost difference pixel) as an origin. However, this is a mere example, and the point of one of the four corners of a rectangular region that is circumscribed about the leftmost pixel, the rightmost pixel, the topmost pixel, and the bottommost pixel may be determined as an origin. That is, for example, the origin may be one of the other three (corner) points: the point determined by the leftmost difference pixel (more precisely, the x coordinate of the leftmost difference pixel) and the bottommost difference pixel (more precisely, the y coordinate of the bottommost difference pixel), the point determined by the rightmost difference pixel (more precisely, the x coordinate of the rightmost difference pixel) and the topmost difference pixel (more precisely, the y coordinate of the topmost difference pixel), and the point determined by the rightmost difference pixel (more precisely, the x coordinate of the rightmost difference pixel) and the bottommost difference pixel (more precisely, the y coordinate of the bottommost difference pixel).

Thus, according to the projection system 100 of the embodiment and its variation, in a projection system where a difference region corresponding to a changed part of a screen is subjected to JPEG compression and transmitted from a PC to a projector, a difference image is cut out from a screen image using a macroblock, which is the unit of processing of JPEG compression, as a unit. Therefore, no shortage of size (part of the image that does not fit in a macroblock) occurs, and accordingly, there is no compensation by an estimated image. Thus, noise is less likely to be included in an edge portion of the difference image received by the projector, so that the difference image has good image quality. Further, part of a projection image projected by the projector where the difference image is combined (in particular, the edge of the combined difference image) has good image quality. Therefore, the whole projection image is expected to have high image quality.

Thus, according to an aspect of the present invention, it is possible to provide an information processor that improves the image quality of a projection image projected by a projector.

Various kinds of images referred to as a “screen image,” “difference image”, “projection image,” “compressed difference image,” etc., in this specification are called “images” for convenience of description, and indicate electronic image data as long as the images are processed by a computer.

Elements, representations, or any combinations of elements according to an aspect of the present invention that are applied to a method, an apparatus, a system, a computer program, a recording medium, etc., are valid as embodiments of the present invention.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority or inferiority of the invention. Although one or more embodiments of the present invention have been described in detail, it should be understood that the various changes, substitutions, and alterations could be made hereto without departing from the spirit and scope of the invention.

What is claimed is:

1. An information processor, comprising:
an image capturing part configured to obtain a screen image displayed on a display part;
a storage part configured to store the screen image each time the screen image is obtained by the image capturing part;
an image comparison part configured to generate one or more difference pixels by comparing a last screen image stored a last time by the storage part and the screen image obtained by the image capturing part;
a difference region determination part configured to determine a smallest rectangular region that includes the one or more difference pixels as a difference region based on a predetermined rectangle formed of a predetermined number of pixels, wherein the screen image is divided using the predetermined rectangle as a unit;
a compressed difference image generation part configured to generate a compressed difference image by performing compression on a difference image using the predetermined rectangle as a unit, wherein the difference region is cut out from the screen image into the difference image; and
an image transmission part configured to transmit the compressed difference image to an image display unit connected to the information processor via a network.

2. The information processor as claimed in claim 1, wherein the screen image is rectangular, and
the rectangular screen image is divided in units of the predetermined number of pixels using a point of one of four corners of the rectangular screen image as an origin for dividing the rectangular screen image.

3. The image processor as claimed in claim 1, wherein the screen image is divided in units of the predetermined number of pixels using a point of one of four corners of a rectangular region that is circumscribed about a leftmost difference pixel, a rightmost difference pixel, a topmost difference pixel, and a bottommost difference pixel of the one or more difference pixels extracted by the image comparison part as an origin for dividing the screen image.

4. The image processor as claimed in claim 1, wherein the compression is JPEG compression.

5. A non-transitory computer-readable recording medium having a program recorded thereon, wherein the program is executed by a processor of an information processor to implement:
an image capturing part configured to obtain a screen image displayed on a display part;
a storage part configured to store the screen image each time the screen image is obtained by the image capturing part;
an image comparison part configured to generate one or more difference pixels by comparing a last screen image stored a last time by the storage part and the screen image obtained by the image capturing part;
a difference region determination part configured to determine a smallest rectangular region that includes the one or more difference pixels as a difference region based on a predetermined rectangle formed of a predetermined number of pixels, wherein the screen image is divided using the predetermined rectangle as a unit;
a compressed difference image generation part configured to generate a compressed difference image by performing compression on a difference image using the predetermined rectangle as a unit, wherein the difference region is cut out from the screen image into the difference image; and
an image transmission part configured to transmit the compressed difference image to an image display unit connected to the information processor via a network.

6. The non-transitory computer-readable recording medium as claimed in claim 5, wherein the screen image is rectangular, and
the rectangular screen image is divided in units of the predetermined number of pixels using a point of one of four corners of the rectangular screen image as an origin for dividing the rectangular screen image.

7. The non-transitory computer-readable recording medium as claimed in claim 5, wherein the screen image is divided in units of the predetermined number of pixels using a point of one of four corners of a rectangular region that is circumscribed about a leftmost difference pixel, a rightmost difference pixel, a topmost difference pixel, and a bottommost difference pixel of the one or more difference pixels extracted by the image comparison part as an origin for dividing the screen image.

8. The non-transitory computer-readable recording medium as claimed in claim 5, wherein the compression is JPEG compression.

9. An information processing method, comprising:
obtaining a screen image displayed on a display part of an information processor;
storing the screen image each time the screen image is obtained by said obtaining;
generating one or more difference pixels by comparing a last screen image stored a last time by said storing and the screen image obtained by said obtaining;
determining a smallest rectangular region that includes the one or more difference pixels as a difference region based on a predetermined rectangle formed of a predetermined number of pixels, wherein the screen image is divided using the predetermined rectangle as a unit;
generating a compressed difference image by performing compression on a difference image using the predetermined rectangle as a unit, wherein the difference region is cut out from the screen image into the difference image; and
transmitting the compressed difference image to an image display unit connected to the information processor via a network.
